(19) United States
(12) Patent Application Publication
(10) Pub. No.: US 2012/0228881 A1
(43) Pub. Date: Sep. 13, 2012

(54) Wind Turbine Having a Lifting Device

(75) Inventor: Sonke Siegfriedsen, Rendsburg (DE)

(73) Assignee: AERODYN ENGINEERING GMBH, Rendsburg (DE)

(21) Appl. No.: 13/512,377

(22) PCT Filed: Nov. 30, 2010
(86) PCT No.: PCT/DE10/01381

§ 371 Date: May 29, 2012

(30) Foreign Application Priority Data
Dec. 1, 2009 (DE) 10 2009 056 245.1

(51) Int. Cl. F03D 11/04

(52) U.S. Cl. 290/55

(57) ABSTRACT

A wind turbine includes a tower, an energy conversion unit arranged substantially outside the upper tower cross-section and having a generator and a rotor with at least one rotor blade connected to a hub, a head carrier arranged on the tower and connecting the energy conversion unit to the tower, and a lifting device having a lifting cable for lifting and lowering the energy conversion unit. A supporting unit is fastened to the head carrier and extends in the longitudinal direction of the energy conversion unit. A redirecting assembly is arranged on the supporting unit for transferring the lifting cable from a substantially horizontal plane to a vertical plane. The redirecting assembly is connected to the head carrier or the supporting unit by a linear drive that causes a position change of the redirecting assembly in the direction of the longitudinal axis of the energy conversion unit.

The invention relates to a wind turbine having a lifting device. The invention in particular relates to a wind turbine having a tower, an energy conversion unit that is arranged substantially outside the upper tower cross-section and that has a generator and a rotor having at least one rotor blade connected to a hub, a head carrier arranged on the tower and connecting the energy conversion unit to the tower, a supporting unit that is fastened to the head carrier and that extends in the longitudinal direction of the energy conversion unit and a cable for lifting and lowering the energy conversion unit

It is known that erecting wind turbines is a complex procedure both technically and, logistically. In particular the large weights of the wind turbine components and their dimensions necessitate the use of special equipment such as for example special cranes whose use is subject to long-term planning especially when installing offshore wind turbines.

For some time there have been attempts to counter this problem by designing the tower of a wind turbine itself as a crane or that it has a crane as an integral part of the wind turbine so that the work usually arising when erecting wind turbines is at least partly minimized.

For example EP 0 783 630 A1 discloses a load lifting device on a wind turbine, where a pivotable crane boom is arranged on the main carrier that is disposed on the tower. The crane exhibits a boom that is arranged in the axis of rotation of the yawing system and that can be pivoted to both sides of the tower. The lifting cable is guided over several pulleys and is finally taken up by a winch or dispensed by it. Even though this is not expressly mentioned, the crane boom is taken up by the nacelle cladding after the erection of the wind turbine, so that the nacelle cladding at first has to be removed again before the crane can be used again.

In like manner, DE 199 55 516 C1 shows a wind turbine and a method for removing and installing the main components of the machine housing of a wind turbine, using which the transmission and the generator of the wind turbine can be pulled up from the floor and moved directly into the nacelle through an opening provided in the floor of the nacelle. To this end, the crane boom is arranged in the interior of the nacelle such that it can be pivoted, it being necessary to open the upper cladding of the nacelle to operate the crane.

It is a disadvantage of these known designs that the crane booms that have been proposed are difficult to construct due to their ability to pivot, and the conventional components of the wind turbine also have to be designed to absorb the forces that occur when the crane boom is used. In addition, the nacelles must be opened to use the crane or the nacelle cladding has to be removed.

WO 2008/148874 A1 also discloses a wind turbine where lifting gear is provided in a frame mounted on the tower of a wind turbine that can, when this wind turbine is erected, lift an energy conversion unit preassembled from a rotor, a hub, rotor blades and generator that is connected to the frame arranged on the tower and thus to the tower. Here the frame has such a design that it projects over the upper tower cross-section so that the energy conversion unit is arranged outside the upper to tower cross-section. Due to this arrangement, the wind turbine can be lifted and can be connected to the frame without any risk of collision with the tower.

Despite this basically advantageous construction, a disadvantage of this previously known wind turbine consists in the fact that the distance of the position where the lifting cable is transferred from a horizontal plane into a vertical plane is predetermined. This in effect places tight limits on the operation of the lifting gear, for example because of upper wind speed limits, that are to guarantee that collision of the energy conversion unit with the tower is prevented.

Booms that can be pivoted and crane winches that can be moved on the nacelle—as as DE 103 27 849 A1 suggests—cannot be used here since they are not designed for the loads occurring when lifting or lowering an energy conversion unit and are not sufficiently secured. On top of this, on account of their exposed position they are subject to the risk of corrosion and weather-related fatigue in extreme climates and are therefore also not suited for safely lifting and lowering over long periods of time. This is true in particular of the drives of the lifting gear and also the lifting cables themselves.

Starting from WO 2008/148874 A1 it is therefore the object of the invention to further develop the known wind turbine in such a. way that the energy conversion unit in its lifted position can be better aligned for connecting to the tower of the wind turbine and it is thus on the whole easier to erect, maintain and repair the wind turbine. Preferably it should also be possible for the devices and means for lifting and lowering the energy conversion unit to reach a service life that is as long as possible.

The object is achieved by the wind turbine having the features of Claim 1. The sub claims specify advantageous developments of the invention.

The invention can be used with particular advantage on the wind turbine that is known from DE 10 2007 012 408 A1. Reference is made to the principle design of this plant known in its entirety. In this wind turbine, the transmission, the generator and. the yawing system are arranged in separate housings that are bolted together, the housings being designed as load transmitting structures for transmitting the maximum static and dynamic rotor loads. The advantages resulting from the known construction are for example a very compact and light overall structure.

The advantage of this preferred design consists in the fact that in particular in the case of installations in the offshore area the entire energy conversion unit can be preinstalled onshore and transported to the erection sites using a vessel and pulled up at the tower of the wind turbine without further aids and can be connected thereto by means of the head carrier. This not only reduces the outlay in terms of logistics and work but also in terms of time, costs and staff that is required to erect single wind turbines or entire wind farms.

On top of this, in the case of a defective (offshore) wind turbine it is readily possible to detach an entire defective energy conversion unit consisting e.g. of a rotor, hub, rotor blades, rotor bearings, transmission and generator, from the tower and to replace it with a functioning energy conversion unit that is brought along to the defective wind turbine, it then being possible for the defective energy conversion unit to be checked at the factory under normal operating conditions and to be repaired by replacing individual components. This is also accompanied by considerable savings in terms of cost and time on account of downtimes that are short even in the case of a damage, as it is also provided in the WO 2008/1133342 A2, it however being possible in the present case to dispense with the crane that is carried along with the vessel.

It is particularly advantageous if the wind turbine to be erected is a two-blade installation since transport of a preassembled energy conversion unit onshore and offshore that has two linearly aligned blades is subject to fewer restrictions due to the vehicle width to be observed during transport in contrast to a preassembled (if only partly) energy conversion unit that has a three-blade rotor.

Finally it is advantageous that the supporting unit is outside the head carrier, so that the inventive lifting device can be used without complex preparation measures, for example removing a cladding. On the other hand, the nacelle that carries the crane boom, is in any case designed for carrying the loads that are arranged outside the upper tower cross-section.

The invention is explained in more detail using an exemplary embodiment of particularly preferred to design, in which:

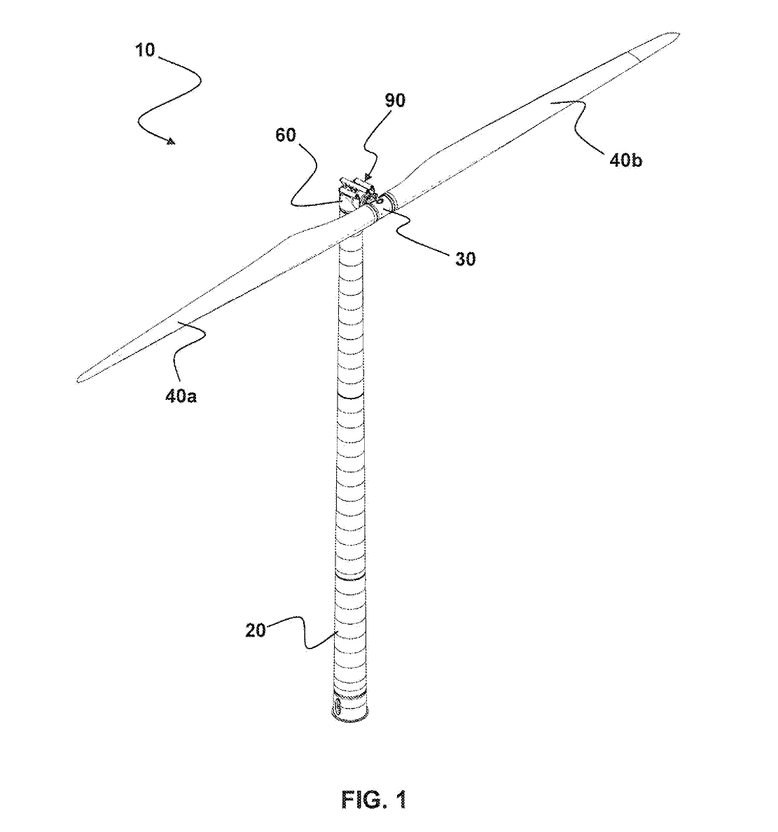

FIG. 1 shows a perspective total view of a wind turbine according to a an exemplary embodiment of particularly preferred design;

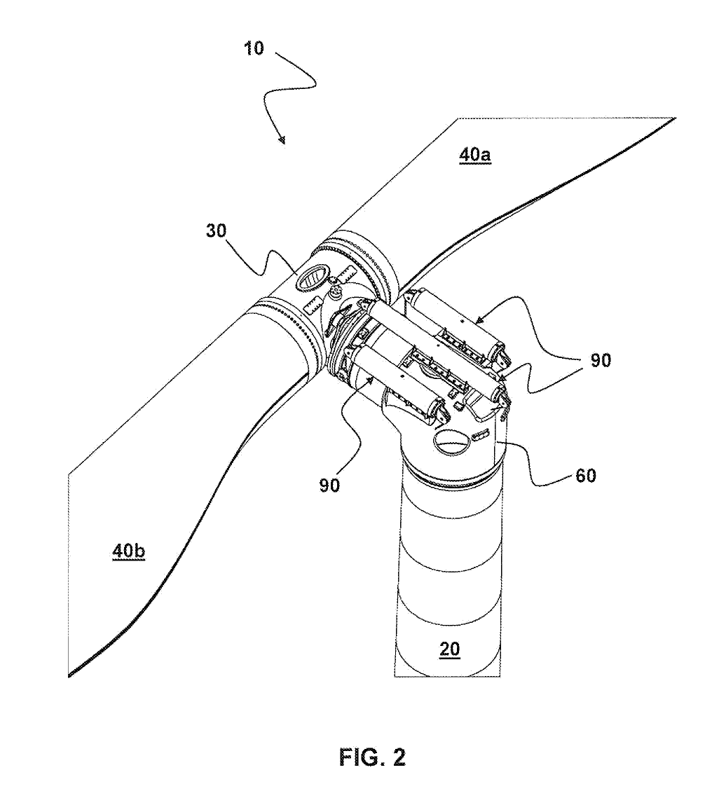

FIG. 2 shows a perspective detailed view of the wind turbine of FIG. 1 in the area of the energy conversion unit that is attached to the head carrier;

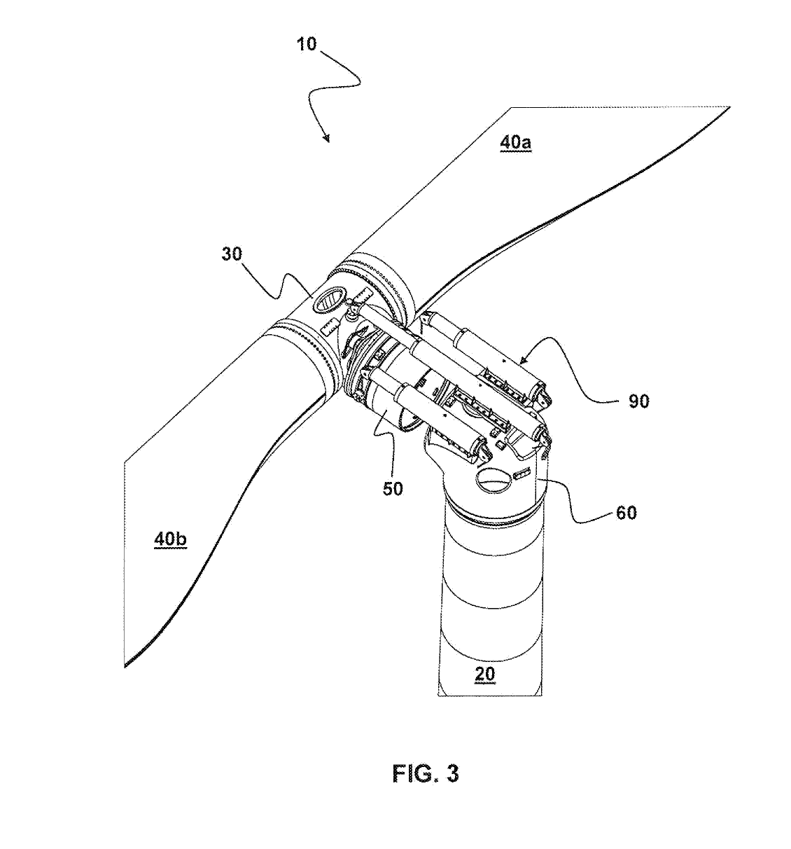

FIG. 3 shows a perspective detailed view of the wind turbine of particularly preferred. design having the energy conversion unit detached from the head carrier;

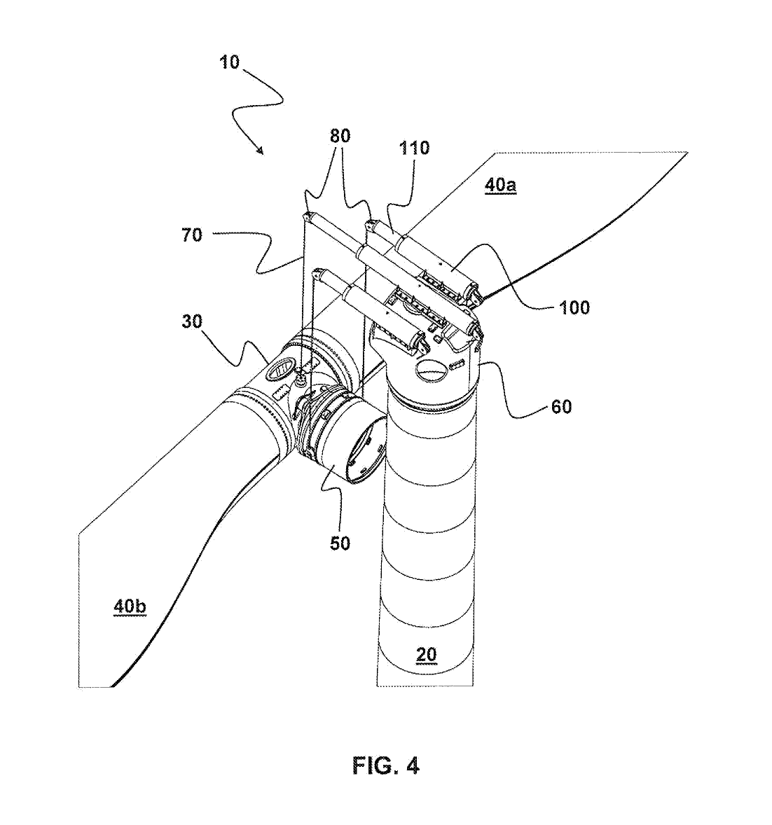

FIG. 4 shows a perspective detailed view of the wind turbine of particularly preferred design having the energy conversion unit detached from the head carrier and slightly lowered;

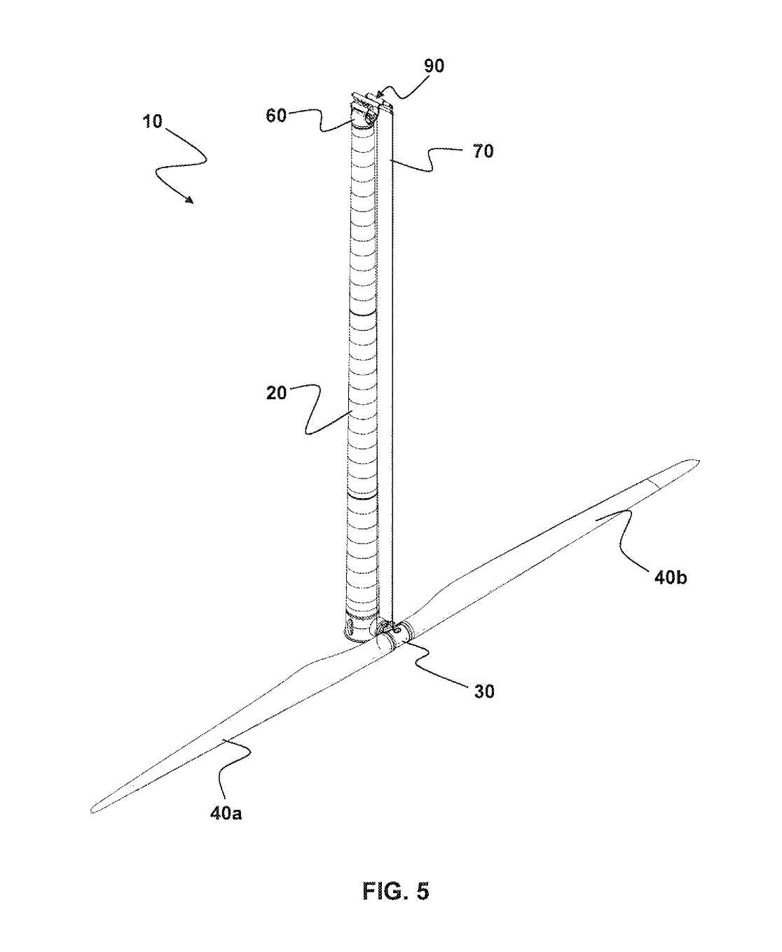

FIG. 5 shows a perspective total view of the wind turbine of particularly preferred design with the energy conversion unit detached from the head carrier and set down at the foot of the tower; and

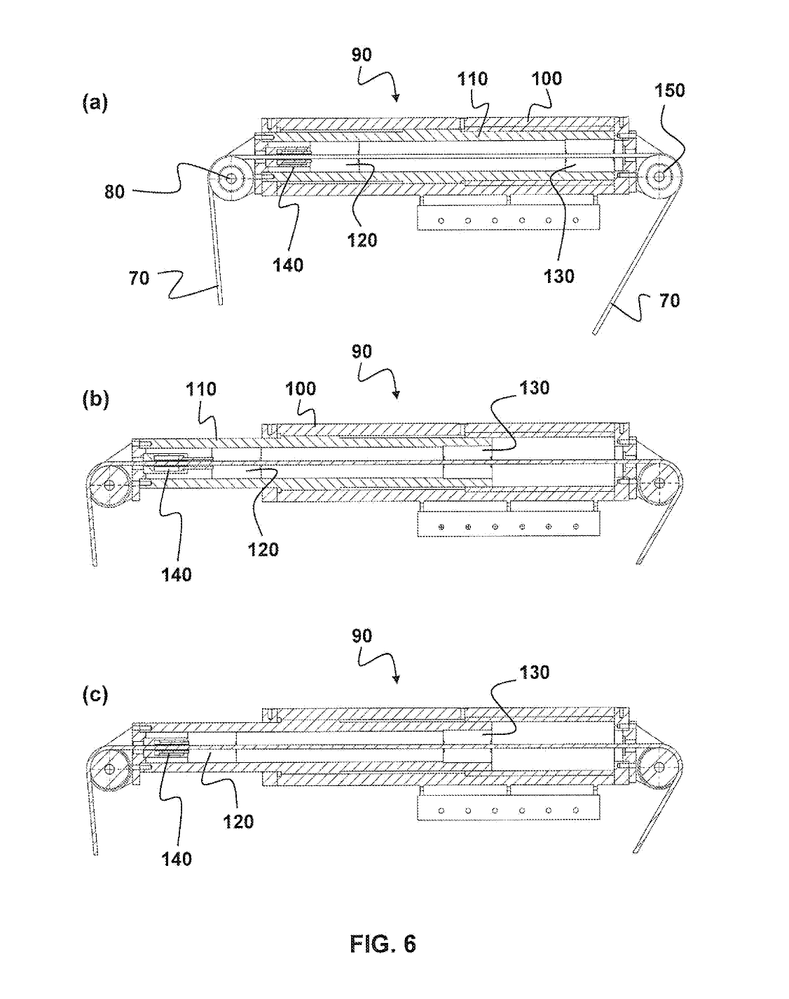

FIG. 6 shows a sectional view of a linear drive of particularly preferred design in the retracted state (a), in the extended state with a retracted grab cylinder (b) and in the extended state with an extended grab cylinder (c).

FIG. 1 shows a perspective total view of a wind turbine whose principle design is known from DE 10 2007 012 408 A1 that is fitted with the inventive lifting device. This wind turbine 10 consists of a tower 20, an element that is preferably designed as a housing and arranged on the tower 20 and referred to as head carrier 60 that is connected on the one side to the tower 20 preferably via a yawing device and on its other side to the energy conversion unit of the wind turbine 10.

The energy conversion unit preferably consists of a rotor with a hub 30 that carries two blades 40a, 40b, the rotor being preferably mounted in a rotor bearing and driving a generator 50 (provided with a reference symbol in FIG. 3) by means of a suitable transmission.

Here it can be seen that the head carrier 60 that connects the energy conversion unit to the tower 20 does not project or hardly projects over the upper tower cross-section and the energy conversion unit is essentially arranged outside the upper tower cross-section. This arrangement facilitates lifting the energy conversion unit at the mounting site at the head carrier 60 or setting it down on account of the fact that the distance between the energy conversion unit and the tower 20 can be complied with easily.

A lifting device of particularly preferred design for lifting and lowering the energy conversion unit, for example for directing a wind turbine or for repairing or replacing the energy conversion unit in the case of a defective wind turbine, is situated at or preferably on the head carrier 60. In the exemplary embodiment shown, the lifting device is integrated into the linear drive 90 so that a particularly compact construction that protects the lifting. device against environmental influences can be achieved.

However in a very simple case the linear drive 90 can also be formed from a supporting unit that is mounted on the head carrier 60 and extends in the direction of the hub. 30 and that can be extended for example like a telescope, and a carriage or traveling crane that run on the supporting unit and carry the redirecting assembly(s).

FIG. 2 shows a magnified perspective detailed view of the wind turbine from FIG. 1 in the area of the head carriers 60. On the head carrier 60, several linear drives 90 that are designed as hydraulic linear cylinders can be seen that form the lifting device. In the present case, three linear drives 90 can be seen, a particularly preferred design providing for an even number of linear drives 90, for example four linear drives 90. The travel of the several linear drives 90 can be identical. Preferably it is however envisaged that the linear drives 90 that are fitted to the head carrier 60 further outside relative to its longitudinal axis have a shorter travel than the linear drives 90 arranged therebetween. While the outer linear drives 90, in the extended state, are to reach approximately up to the area above the centre of gravity of the entire energy conversion unit, the inner linear drives 90 are extended beyond this point and preferably positioned up to a point where they reach over the hub 30 of the energy conversion unit. This arrangement facilitates removing and attaching the energy conversion unit that is mounted on the head carrier and frequently tilted by up to 5°, since the energy conversion unit with the inside linear drives 90 arranged between the linear drives 90 arranged outside can be tilted.

FIG. 3 shows a perspective detailed view of the winds turbine 10 of particularly preferred design with the energy conversion unit detached from the head carrier 60. It can be clearly seen that the energy conversion unit, in particular the generator 50 or the generator housing 50 is separate from the head carrier 60 and spaced apart and depends from the extended linear drives 90.

This takes place, as FIG. 4 shows more clearly, in that the linear drive 90 is formed from an outer cylinder 100 and an inner cylinder HO that can be mutually displaced, preferably hydraulically. At its free end, the inner cylinder 110 carries a redirecting assembly 80 for transferring the lifting cable 70 from an essentially horizontal plane into a vertical plane. The lifting cable 70 is attached at pivot points at the hub 30 or at other sections of the energy conversion unit, e.g. at the generator housing or, as in this case, at the generator housing and depends from the several redirecting assemblies 80 of the several linear drives 90.

FIG. 5 finally shows an energy conversion unit that has been completely removed, starting from FIG. 1 and by means of the method steps shown in FIGS. 2, 3 and 4 and lowered to the foot of the tower 20 of the wind turbine 10.

The wind turbine 10 of inventive design makes it possible that an energy conversion unit mounted on the head carrier 20 is connected to a lifting device preferably by means of several lifting cables 70 that are guided over several redirecting assemblies 80. After loosening the connection between the energy conversion unit and the head carrier 60, the redirecting assemblies 80 are extended away from the tower 20 by means of linear drives 90 so as to increase the distance of the energy conversion unit from the tower 20, it preferably also being possible to change the angle of the longitudinal axis of the energy conversion unit. Having an increased distance from the tower 20, the energy conversion unit can be lowered and transported away.

Using the lowering process of a defective energy conversion unit, the procedure, carried out with the inventive wind turbine 10, of lifting or lowering the energy conversion unit of the wind turbine 10 is explained in more detail. For lowering and setting down the energy conversion unit at first it is necessary that the lifting cables 70 are attached to the pivot points at the energy conversion unit as long as these are not permanently fixed to the lifted energy conversion unit that is mounted to the head carrier 60. However, for fastening. the lifting cables 70 on the hub 30, it is necessary to extend the drive inside lying linear drive or drives 90 so that their respective redirecting assembly 80 is positioned above the pivot points provided at the hub 30, the lifting cable 70 can be lowered and can be attached (manually) with the pivot point to the hub 30.

Prior to releasing the flange connection of the energy conversion unit and the head carrier 60, also in particular of the connection of the generator housing 50 and the head carrier 60, all lifting cables 70 are pre-tensioned so that the weight of the energy conversion unit can be absorbed immediately and the flange connection can be released without any problems. Several sensors are provided for this purpose that detect the pressure on the flange, the pressure in the lifting cylinders and/or the loads existing on the lifting cables 70 and provide to the corresponding values to a control system that acts on the elements that form the lifting device and adjusts the pretension of the lifting cables 70.

After the connection between the energy conversion unit and the head carrier 60 has been released, all linear drives 90 are extended and the energy conversion unit, that has been released from the head carrier 60 is brought in a horizontal direction into a position that is further remote from the tower 20 of the wind turbine. Extending the linear drives 90 in this case has to take place in such a coordinated manner that the redirecting assemblies 80 are simultaneously extended with the identical speed and the entire energy conversion unit is shifted parallel in the horizontal direction.

Also the lowering of the energy conversion unit from the extended position has to take place in a coordinated manner. For this purpose for example an inclinometer can be installed at the hub 30 whose measurement data are transmitted wirelessly to the control system. On the basis of these measurement data the control system ensures that the energy conversion unit is not twisted or tilted when being lowered. That is, the energy conversion unit should be lowered, aligned horizontally. As an alternative or in addition, also the length of the cable that has been spent should be checked, it been possible here to have recourse to the conventional systems for measuring the length of cables, for example by means of a friction wheel that preferably is the redirecting assembly 80 itself, or using marks introduced into the lifting cables 70. In the process, also giving out an identical cable length of each lifting cable 70 from each redirecting device 80 provides for a parallel offset of the energy conversion unit in the vertical direction until the energy conversion unit has been set down completely on the floor. As an alternative, the control system can also be arranged, according to the wind situation, such that the lifting cables 70 are controlled differently and independently of each other for example by means of the linear drives 90 (see below) that shift the front clamping device 140, for example to counteract wind loads that act non-uniformly on the energy conversion unit and to prevent a displacement of the energy conversion unit that has been released from the head carrier 60.

Likewise it is possible for an energy conversion unit, when erecting a wind turbine 10 or as a replacement of a defective energy conversion unit, to be lifted to the head carrier 60, possibly tilted, moved inwards by means of the linear drives 90 and connected to the head carrier 60.

In addition to the features mentioned above, the energy conversion unit can exhibit a device that makes it possible for the energy conversion unit to be supported at the tower 20 in a guided manner when the energy conversion unit is lifted or set down. It can consists of a frame provided with wheels, it been possible for the distance of the wheels from the energy conversion unit to be changed for example by means of further linear drives so they can be adapted to the tower diameter that changes in the longitudinal direction of the tower 20. The device can also be provided as an apparatus that is separate from the energy conversion unit and that can be connected to the energy conversion unit when necessary.

It is also possible for a framework to be provided that receives the energy conversion unit at the foot of the tower for transporting or storing the energy conversion unit.

FIG. 6 finally shows a linear drive of particularly preferred design that exhibits the elements that carry out the lifting process. The linear drive 90 is preferably formed from an outer cylinder 100 and an inner cylinder 110, the two cylinders 100, 110 being designed such that they can be shifted relative to each other and the outer cylinder 100 receives the inner cylinder 110 in the retracted state. The displace ability of the inner cylinder 110 relative to the outer cylinder 100 or the telescopability of the linear drive 90 is ensured by a hydraulic system that is designed for the appropriate loads.

The two cylinders 100, 110 are designed as hollow cylinders 100, 110, the lifting cable 70 being guided through the cavity formed by the outer and the inner hollow cylinders 100, 110. At the end of the linear drive 90 facing away from the tower 20, the lifting cable 70 is guided over the redirecting assembly 80 that is arranged on the inner hollow cylinder 110, so that the lifting cable 70 is transferred from an essentially horizontal plane into a vertical plane. On that side of the linear drive 90 facing the tower 20, preferably a. further redirecting assembly 150 that is connected to the outer hollow cylinder 100 is provided, over which the lifting cable 70 is guided through the wall of the head carrier 60 into the tower 20 of the wind turbine 10. That is, if the lifting device is not needed, the linear drive 90 is retracted (see FIG. 1A) and the lifting cable 70 can be stored completely, preferably suspended centrally in the tower 20.

In a particularly preferred manner, the linear drive 90 also exhibits the components for lifting and/or lowering the lifting cable 70, that is the lifting device per se. To this end, two preferably hydraulically operated cable clamps 120, 130 are provided that are preferably arranged in the inner hollow cylinder 110. One of the cable clamps 120 is designed such that it can be moved in the inner hollow cylinder 100 preferably by means of a further hydraulic cylinder, whereas the other cable clamp 130 is fixed in its position in the inner hollow cylinder 110.

The lifting process is effected by a control system acting on the cable clamps 120, 130 and the further hydraulic cylinder, that controls a reciprocal clamping of the lifting cable 17 by the cable clamps 120, 130. For example in a first step the rear cable clamp 130 that is remote from the redirecting assembly 80 that carries the energy conversion unit is controlled to clamp the lifting cable 70 that is guided through the hollow cylinders 100, 110. Then the further hydraulic cylinder can move the cable clamp 120 that is arranged on the front end, facing the energy conversion unit, of the inner hollow cylinder 110 into the desired position, for example in the direction of the tower 20, without clamping the lifting cable 70, and clamped the lifting cable 70 firmly in this position (see FIG. 1b). Then the rear cable clamp 130 is released and the front cable clamp 110 clamping the lifting cable 70 is moved in the direction of the free end of the inner hollow cylinder 110. With this process, the cable 70 or the energy conversion unit is lowered in the direction of the tower foot. Then the rear cable clamp 130 is controlled again to clamp the lifting cable 70 and camping of the front cable clamp 120 is released, whereupon a new movement and camping cycle can take place that results in the lifting cable 70 or the energy conversion unit being lowered.

For lifting the energy conversion unit, the lifting cable 70 is reeled in by the front and rear cable clamps 120, 130 cooperating, in that at first the rear cable clamp 130 fixes the lifting cable 70. Then the front cable clamp 120 is moved to the front without clamping the lifting cable 70. Following this, the front cable clamp 120 clamps the lifting cable 70 and the rear cable clamp 130 releases the lifting cable 70. Then the further hydraulic cylinder moves the front cable clamp 120 into a rear position, as a result of which the lifting cable is guided further in the direction of the tower 20 and the energy conversion unit is being lifted.

1-10. (canceled)

11. A wind turbine comprising:
a tower,
an energy conversion unit that, is arranged substantially outside the upper tower cross-section and that has a generator and a rotor having at least one rotor blade connected to a hub,
a head carrier arranged on the tower and connecting the energy conversion unit to the tower, and
a lifting device having a lifting cable for lifting and lowering the energy conversion unit
characterized in that
the lifting device is formed by several hydraulic linear cylinders that are formed in each case from an outer hollow cylinder and an inner hollow cylinder that can be displaced relative to the outer hollow cylinder,
each inner hollow cylinder having at its free end a redirecting assembly for transferring a lifting cable from a substantially horizontal plane to a vertical plane and the lifting cable being guided through the cavity formed by the outer and the inner cylinders.

2. The wind turbine according to claim 1, characterized by at least one cable clamp arranged in the inner hollow cylinder.

3. The wind turbine according to claim 2, characterized in that the cable clamp can be moved hydraulically in the longitudinal direction in the inner hollow cylinder for lifting or lowering the lifting cable.

4. The wind turbine according to claim 1, characterized by a cable clamp arranged in the outer hollow cylinder.

5. The wind turbine according to claim 2, characterized by a cable clamp arranged in the outer hollow cylinder.

6. The wind turbine according to claim 3, characterized by a cable clamp arranged in the outer hollow cylinder.

7. The wind turbine according to claim 2, characterized in that the cable clamps are hydraulically operated cable clamps.

8. The wind turbine according to claim 3, characterized in that the cable clamps are hydraulically operated cable clamps.

9. The wind turbine according to claim 4, characterized in that the cable clamps are hydraulically operated cable clamps.

10. The wind turbine according to claim 1, characterized in that the supporting unit extends on both sides of the energy conversion unit.

11. The wind turbine according to claim 2, characterized in that the supporting unit extends on both sides of the energy conversion unit.

12. The wind turbine according to claim 3, characterized in that the supporting unit extends on both sides of the energy conversion unit.

13. The wind turbine according to claim 4, characterized in that the supporting unit extends on both sides of the energy conversion unit.

14. The wind turbine according to claim 7, characterized in that the supporting unit extends on both sides of the energy conversion unit.

15. The wind turbine according to claim 1, characterized in that that end of the lifting cable facing the tower is supported such that it is suspended in the tower.

16. The wind turbine according to claim 2, characterized in that that end of the lifting cable facing the tower is supported such that it is suspended in the tower.

17. The wind turbine according to claim 3, characterized in that that end of the lifting cable facing the tower is supported such that it is suspended in the tower.

18. The wind turbine according to claim 4, characterized in that that end of the lifting cable facing the tower is supported such that it is suspended in the tower.

19. The wind turbine according to claim 7, characterized in that that end of the lifting cable facing the tower is supported such that it is suspended in the tower.

20. The wind turbine according to claim 10, characterized in that that end of the lifting cable facing the tower is supported such that it is suspended in the tower.
